(19) United States
(12) Patent Application Publication
(10) Pub. No.: US 2012/0170072 A1
(43) Pub. Date: Jul. 5, 2012

(54) DISPLAY DEVICE

(75) Inventors: Shinichi Miyazaki, Osaka (JP); Kengo Takahama, Osaka (JP)

(73) Assignee: SHARP KABUSHIKI KAISHA, Osaka (JP)

(21) Appl. No.: 13/496,041

(22) PCT Filed: Apr. 27, 2010
(86) PCT No.: PCT/JP2010/057458

§ 371 Date: Mar. 14, 2012

(30) Foreign Application Priority Data
Sep. 18, 2009 (JP) 2009-217818

(51) Int. Cl. G06F 15/00; G02B 27/12

(52) U.S. Cl. 358/1.13; 359/619

(57) ABSTRACT

A liquid crystal display device 1 has a liquid crystal display panel 11 that includes an optical sensor element 4 and a protection plate 21 that protects the liquid crystal display panel 11. The protection plate 21 and the liquid crystal display panel 11 are arranged with an air layer 25 therebetween. Between the liquid crystal display panel 11 and the protection plate 21, lens arrays 23 and 24 that form an image with light emitted from the liquid crystal display panel 11 as an erect image on a surface of the protection plate 21 and that forms, when an original 30 is placed on the protection plate 21, an image with reflected light of light irradiated onto the original 30 as an erect image on the optical sensor element 4 are provided. Thus, a display device having an image reading function that can protect the display panel and that can suppress lowering of resolution of a read out image and lowering of the display quality of a displayed image is provided.

### TECHNICAL FIELD

The present invention relates to a display device that has an image reading function.

### BACKGROUND ART

In recent years, a two-dimensional image sensor in which photoelectric conversion elements, which convert received light into an electrical signal, are arranged two-dimensionally has been known as an image reading device that does not need mechanical scanning such as a laser scanner and the like. Patent Document 1 discloses a thin authentication sensor having the photoelectric conversion elements, for example.

FIG. 14 is a cross-sectional view showing a configuration of the thin authentication sensor described in Patent Document 1.

As shown in FIG. 14, a thin authentication sensor 100 is constituted of an image sensor 101, microlens arrays 103D and 103E, and a filter 104.

On a surface of the image sensor 101, a plurality of openings of the photoelectric conversion elements, which are independently formed, are arranged. The respective microlenses of the microlens arrays 103D and 103E have positive light collection power, and are disposed so as to face each other.

The filter 104 transmits only the near infrared rays, and protects the image sensor 101 and the microlens arrays 103D and 103E.

As shown in FIG. 14, the thin authentication sensor 100 is configured such that the respective microlenses of the pair of microlens arrays 103D and 103E collect near infrared light transmitted through the filter 104 out of the brightness information of a point (focal position FPO) in space included on a focal plane FPL on a side of an object on the filter 104 using positive light collecting power to set the focus to be at the opening of the image sensor 101. According to the configuration of this thin authentication sensor 100, the distance from the focal plane FPL on the side of the object to the image sensor 101 can be reduced.

### RELATED ART DOCUMENTS

### Patent Documents

Patent Document 1: Japanese Patent Application Laid-Open Publication, “Japanese Patent Application Laid-Open Publication No. 2008-168118 (Published on Jul. 24, 2008)”

Patent Document 2: Japanese Patent Application Laid-Open Publication, “Japanese Patent Application Laid-Open Publication No. 2007-304609 (Published on Nov. 22, 2007)”

Patent Document 3: Japanese Translation of PCT International Application Publication, “Japanese Translation of PCT International Application Publication No. 2008-541425 (Published on Nov. 20, 2008)”

Patent Document 4: Japanese Patent Application Laid-Open Publication, “Japanese Patent Application Laid-Open Publication No. 2000-66002 (Published on Mar. 3, 2000)”

Patent Document 5: Japanese Patent Application Laid-Open Publication, “Japanese Patent Application Laid-Open Publication No. 2006-167594 (Published on Jun. 29, 2006)”

Patent Document 6: Japanese Patent Application Laid-Open Publication, “Japanese Patent Application Laid-Open Publication No. 2008-158114 (Published on Jul. 10, 2008)”

Patent Document 7: Japanese Translation of PCT International Application Publication, “Japanese Translation of PCT International Application Publication No. 2009-509204 (Published on Mar. 5, 2009)”

### SUMMARY OF THE INVENTION

### Problems to be Solved by the Invention

As described above, this two-dimensional image sensor authenticates a finger print or a finger vein pattern, which are objects, by photoelectric conversion of received light.

Thus, it is possible to consider that the display device equipped with light receiving elements as area sensors as described above can be used as a display device having an image reading function.

However, the image sensor 101 disclosed in Patent Document 1 does not display images, and erect images cannot be obtained. Furthermore, the image sensor 101 of Patent Document 1 performs biometric authentication by photographing a fingerprint or a vein pattern, and does not read out an image of an original. Thus, the image sensor 101 disclosed in Patent Document 1 cannot be applied in a display device directly.

Furthermore, in order to actually commercialize a display device having a built-in light receiving element, a protection member needs to be disposed on an image display surface of a display panel to protect the display panel from an object for image reading placed thereon. Further, if a surface of the protection member, which is the surface on which the object for image reading is placed, is pressed by a finger or a pen, an air layer needs to be provided between the display panel and the protection member in order to protect the display panel from their stress.

However, when the protection member is disposed on the image display surface of the display panel as described and when the above-mentioned air layer is provided, the optical distance between the light receiving element and the placed object for image reading increases. Because of this, actual resolution of an image read out by the light receiving element and an image displayed by the display panel decreases significantly.

The present invention seeks to address the above-mentioned problems, and its object is to provide a display device having an image reading function that can protect the display panel and that can suppress lowering of resolution of a read out image and a displayed image.

### Means for Solving the Problems

In order to solve the above-mentioned problems, a display device according to the present invention is a display device having an image reading function that includes a display panel having a light receiving element; and a protection member protecting the display panel, wherein in performing the image reading function, an intensity of reflected light of light irradiated onto an object for image reading disposed on the protection member is detected by the light receiving element to read out image information of the object for image reading. The display panel and the protection member are arranged with a gap therebetween. The display device includes, between the display panel and the protection member, an optical member that forms an image with light emitted from the display panel as an erect image on a surface of the protection member and that forms, when an object for image reading is disposed on the protection member, an image with reflected light of light irradiated onto the object for image reading as an erect image on the light receiving element.

According to the configuration above, the object for image reading is not placed directly on the display panel because the display device has the protection member. Furthermore, even if stress is added to the protection member when the object for image reading is placed on the protection member, stress to the display panel can be prevented because the display panel and the protection member are arranged with a gap between them. As a result, the display panel can be protected.

Further, the optical member forms an image with light emitted from the display panel as an erect image on a surface of the protection member. When an object for image reading is disposed on the protection member, the optical member forms an image with reflected light of light irradiated onto the object for image reading as an erect image on the light receiving element. Therefore, visual characteristics can be made equal to those of when the optical member is not disposed.

Further, according to the configuration above, the optical member is provided between the display panel and the protection member. Therefore, even if the distance between the image display surface, which also functions as a surface on which an object for image reading is placed, and the display panel increases because of the protection member, it is possible to suppress lowering of the display quality of an image displayed on the surface of the protection member, and it is possible to suppress lowering of resolution of a read out image detected by the light receiving element. Here, the display quality means visual characteristics, blurriness (resolution), contrast, and the like.

Thus, according to the configuration above, a display device having an image reading function that can protect the display panel and that can suppress lowering of resolution of a read out image and lowering of the display quality of a displayed image can be provided.

### EFFECTS OF THE INVENTION

A display device according to the present invention is a display device having an image reading function that has a display panel having a light receiving element; and a protection member protecting the display panel, wherein in performing the image reading function, the intensity of reflected light of light irradiated onto an object for image reading disposed on the protection member is detected by the light receiving element to read out image information of the object for image reading. The display panel and the protection member are arranged with a gap therebetween. The display device includes, between the display panel and the protection member, an optical member that forms an image with light emitted from the display panel as an erect image on a surface of the protection member and that forms, when an object for image reading is disposed on the protection member, an image with reflected light of light irradiated onto the object for image reading as an erect image on the light receiving element.

Therefore, according to the configuration above, a display device having an image reading function that can protect the display panel and that can suppress lowering of resolution of a read out image and lowering of the display quality of a displayed image can be provided.

### BRIEF DESCRIPTION OF THE DRAWINGS

FIG. 1 is a cross-sectional view schematically showing a configuration of a liquid crystal display device according to Embodiment 1 of the present invention.

FIG. 2 is a cross-sectional view showing a configuration of a main portion of a liquid crystal display panel used in the liquid crystal display device shown in FIG. 1.

FIG. 3 is a cross-sectional view schematically showing a configuration of a main portion of the liquid crystal display device shown in FIG. 1.

FIG. 4 is a cross-sectional view showing a configuration of a main portion of a liquid crystal display device having a built-in optical sensor element in which a lens array is not provided and paths of light reflected by an original.

FIG. 5 is a figure showing a blur function of an image read out by an optical sensor element of a liquid crystal display device having no lens array.

FIG. 6 is a graph showing a relationship between the optical distance between a light receiving surface of an optical sensor element and an object for image reading and the actual resolution in a liquid crystal display device having no lens array.

FIG. 7 is a cross-sectional view schematically showing a configuration of a liquid crystal display device according to Embodiment 2 of the present invention.

FIG. 8 is a cross-sectional view showing a configuration of a main portion of the liquid crystal display device shown in FIG. 7.

FIG. 9 is a cross-sectional view explaining paths of light emitted from a liquid crystal display panel of the liquid crystal display device shown in FIG. 1.

FIG. 10 is a cross-sectional view showing a configuration of a main portion of the liquid crystal display device shown in FIG. 9.

FIG. 11 is a cross-sectional view showing a configuration of a liquid crystal display device in which a diffusion plate is disposed.

FIG. 12 is a cross-sectional view schematically showing a configuration of a liquid crystal display device according to Embodiment 3 of the present invention.

FIG. 13 is a cross-sectional view showing a configuration of an image display device described in Patent Document 2.

FIG. 14 is a cross-sectional view showing a configuration of a thin authentication sensor described in Patent Document 1.

### DETAILED DESCRIPTION OF EMBODIMENTS

Embodiments of the present invention are described below in detail.

### Embodiment 1

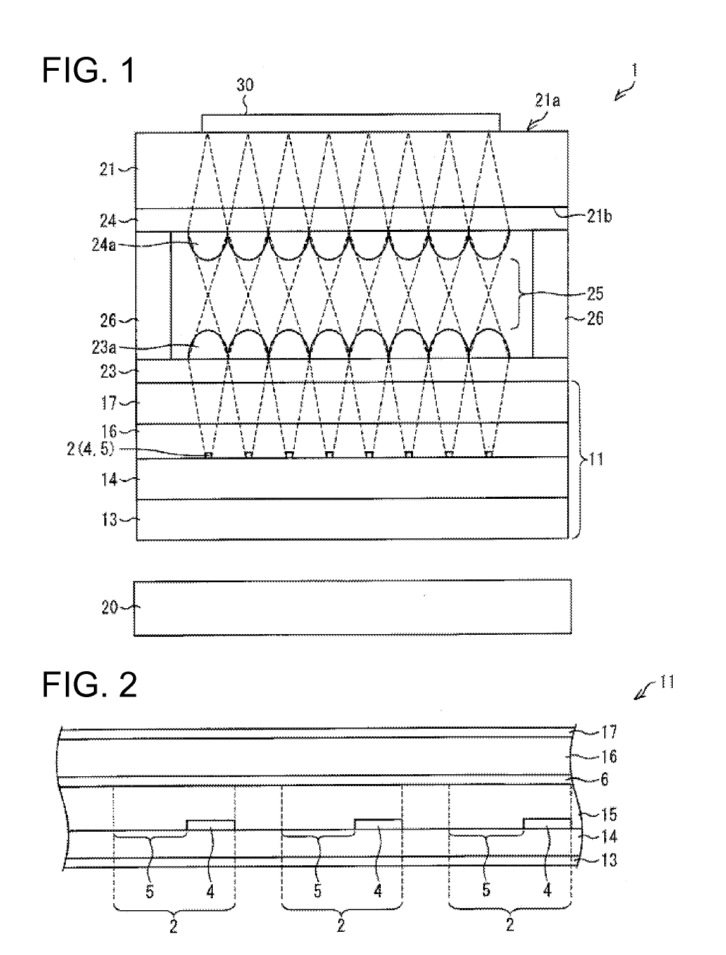

First, using FIGS. 1 and 2, a configuration of a liquid crystal display device according to the present embodiment is described.

The liquid crystal display device of the present embodiment is a liquid crystal display device of a built-in optical sensor element type having an image reading function (scanner function).

Therefore, the liquid crystal display device above functions as an image display device. In addition, it functions as an image reading device in which the intensity of reflected light of light irradiated onto an object for image reading such as an original or the like is detected by an optical sensor element to read out image information of the object for image reading.

FIG. 1 is a cross-sectional view schematically showing a configuration of a liquid crystal display device of the present embodiment. FIG. 2 is a cross-sectional view showing a configuration of a main portion of a liquid crystal display panel used in the liquid crystal display device shown in FIG. 1. Here, in FIG. 1, only an active matrix substrate, optical sensor elements, a color filter substrate, and a polarizing plate are shown as the liquid crystal display panel, and other components are omitted.

As shown in FIG. 1, a liquid crystal display device 1 according to the present embodiment has a liquid crystal display panel 11, a protection plate 21 (protection member) protecting the liquid crystal display panel 11, lens arrays 23 and 24 (optical members) and spacers 26 and 26, which are disposed between the liquid crystal display panel 11 and the protection plate 21, and a backlight 20 that irradiates light onto the liquid crystal display panel 11.

Here, in the description below, surfaces of the respective members constituting the liquid crystal display device 1 on the side on which the backlight 20 is disposed are referred to as “rear surfaces,” and surfaces on the side where a user is located to view images displayed by the liquid crystal display device 1 (i.e., the surfaces on the image display surface side) are referred to as “front surfaces.”

The liquid crystal display device 11 according to the present embodiment is an active matrix type liquid crystal display device in which a plurality of pixels are arranged in a matrix. As shown in FIG. 2, the liquid crystal display panel 11 is configured such that an active matrix substrate 14 and a color filter substrate 16 are arranged to face each other through a liquid crystal layer 15.

Further, on the respective outer surfaces of the active matrix substrate 14 and the color filter substrate 16, polarizing plates are respectively provided. In the present embodiment, the polarizing plate disposed on the outer surface of the active matrix substrate 14 is referred to as a rear polarizing plate 13, and the polarizing plate disposed on the outer surface of the color filter substrate 16 is referred to as a front polarizing plate 17.

On the color filter substrate 16, a color filter layer 6, an opposite electrode (not shown in the figure), an alignment film (not shown in the figure), and the like are formed.

The color filter layer 6 is constituted of a colored portion constituted of color filters that transmit lights of red (R), green (G), and blue (B), respectively, and a black matrix that shields light. A single pixel is constituted of three subpixels, and the color filters, which transmit lights of the respective colors, are respectively provided corresponding to the respective subpixels. The black matrix is disposed between these color filters that are adjacent to each other.

The active matrix substrate 14 has TFTs (not shown in the figure), which are switching elements for driving the respective pixels, pixel electrodes (not shown in the figure), an alignment film (not shown in the figure), optical sensor elements 4 (light receiving elements), and the like.

The optical sensor elements 4 are constituted of photosensors, such as photodiodes, phototransistors, and the like, for example, and transform received light into an electric signal having a value corresponding to the intensity of received light (amount of received light).

In the present embodiment, the optical sensor elements 4 are provided corresponding to the respective pixels. Of respective pixel regions 2 corresponding to the respective pixels on the active matrix substrate 14, regions that exclude the regions (sensor portions) where the optical sensors 4 are disposed and that transmit light emitted from the backlight 20 are hereinafter referred to as display cells 5.

Thus, in each pixel region 2, the sensor portion, which is a region where the optical sensor element 4 is provided, and the display cell 5 having the TFT, which is the switching element, for displaying an image are arranged next to each other. The surface of the active matrix substrate 14 on which the optical sensor elements 4 are arranged is the sensor surface.

In order to make the liquid crystal display device 1 function as an image display device, the display cells 5 are used as regions contributing to display images. On the other hand, in order to make the liquid crystal display device 1 function as an image reading device, the display cells 5 are used as regions for transmitting light emitted from the backlight 20 to illuminate an object for image reading, such as an original 30 shown in FIG. 1 or the like.

Here, between the optical sensor elements 4 in the sensor portions and the active matrix substrate 14, a light shielding film for preventing the light emitted from the backlight 20 from entering the optical sensor elements 4 from the rear surfaces of the optical sensor elements 4 may be provided.

The optical sensor elements 4 and TFTs can be monolithically formed on the active matrix substrate 14 by substantially the same processes, for example. Thus, some of the components of the optical sensor elements 4 may be formed at the same time as some of the components of the TFTs. This method of forming the optical sensor elements can be performed according to a method of manufacturing a conventionally known liquid crystal display device having built-in optical sensor elements.

The protection plate 21 is disposed away from the liquid crystal display panel 11 (i.e., with a gap therebetween) on the side of the liquid crystal display panel 11 opposite from the backlight 20. Between the liquid crystal display panel 11 and the protection plate 21, an air layer 25 formed of the plurality of spacers 26 is provided.

The protection plate 21 is a light guide member formed of a transparent material, such as acrylic resin, glass, or the like. A surface 21a (i.e., the surface on the opposite side from the side on which the liquid crystal display panel 11 is disposed) of the protection plate 21 is a surface on which an object for image reading such as the original 30 or the like is placed, and is also an image display surface to display an image when light emitted from the liquid crystal display panel 11 is formed as an image.

Here, the liquid crystal display device can also function as a liquid crystal display device having an integrated touch panel because it has the built-in optical sensor elements. In that case, the surface 21a of the protection plate 21 is used as a touch surface.

As described above, when using the liquid crystal display device as the liquid crystal display device having an integrated touch panel, the surface 21a of the protection plate 21 is the image display surface, which is also used as the touch surface. As a result, deviation of a read out image of an object for image reading placed on the touch surface from an image displayed on the touch surface caused by parallax can be improved.

When the liquid crystal display device 1 functions as an image reading device (scanner) for reading image information printed on the original 30, the protection plate 21 protects the front polarizing plate 17 and the liquid crystal display panel 11 from stress, scratches, and dirt. Furthermore, when the surface 21a of the protection plate 21 is pressed by a finger, a pen, or the like, the liquid crystal display panel 11 can be protected from their stress because the air layer 25 is disposed between the protection plate 21 and the liquid crystal display panel 11.

Here, when a viewer only needs to read an image displayed by the liquid crystal display panel 11, it is preferable if members that optically reflect or refract light, such as the protection plate 21, the air layer 25, a lens member, and the like, are not disposed between the liquid crystal display panel 11 and the viewer. However, when the liquid crystal display device 1 functions as the image reading device (scanner), such is not practical because the liquid crystal display panel 11 cannot be protected from the object from which the image information is read out as described above.

On the front polarizing plate 17 of the liquid crystal display panel 11, the lens array 23 (first lens member) having a positive refractive index is disposed.

Further, on a rear surface 21b, which is the opposite surface from the front surface 21a of the protection plate 21, the lens array 24 (second lens member) having a positive refractive index is disposed.

The lens arrays 23 and 24 are lens arrays in which a plurality of convex lenses 23a and 24a are arranged respectively. The respective convex lenses 23a and 24a are arranged to face each other.

The lens array 23 and the lens array 24 are disposed away from each other by the spacers 26 formed between the lens arrays 23 and 24. Thus, the lens array 23 and the lens array 24 are arranged to face each other through the air layer 25.

The lens arrays 23 and 24 forms an image with light emitted from the liquid crystal display panel 11 as an erect image on the surface of the protection plate 21. When the original 30 (object for image reading) is placed on the surface 21a of the protection plate 21, they form an image (collect light) with reflected light of light irradiated onto the original 30 as an erect image on the optical sensor elements 4 of the liquid crystal display panel 11.

Here, of the lens array 23 and the lens array 24, if the lens array 23 is not disposed and only the lens array 24 is disposed, for example, it is impossible to form an image with the light emitted from the liquid crystal display panel 11 as an erect image on the surface of the protection plate 21. Furthermore, it is impossible to form an image with reflected light of the light irradiated onto the original 30 as an erect image on the optical sensor elements 4 in the liquid crystal display panel 11. When an erect image cannot be obtained as described above, visual characteristics of pixels become reversed if an image is formed with light emitted from the liquid crystal display panel 11 on the surface of the protection plate 21 and when an image is formed with reflected light of light irradiated onto the original 30 on the optical sensor elements 4, resulting in a sense of discomfort.

Therefore, by providing the lens arrays 23 and 24, an image can be formed with light emitted from the liquid crystal display panel 11 as an erect image on the surface of the protection plate 21, and an image can be formed with reflected light of the light irradiated onto the original 30 as an erect image on the optical sensor elements 4 in the liquid crystal display panel 11. As a result, visual characteristics can be equal to those of when the optical members are not provided.

As described above, in the liquid crystal display device 1, the lens arrays 23 and 24 form an image with reflected light of the light irradiated onto the original 30 on the optical sensor elements 4 in the liquid crystal display panel 11, and the optical sensor elements 4 generate a current corresponding to the intensity of received light based on a difference in reflectance of an image printed on the original 30. This way, the image reading function (scanner function) to read out image information written on the original 30 can be achieved.

The lens arrays 23 and 24 are respectively arranged such that the focal points of light entering the respective convex lenses 23a of the lens array 23 through the liquid crystal display panel 11 and the focal points of light entering the respective convex lenses 24a of the lens array 24 though the protection plate 21 coincide with each other and such that the positions of the corresponding the focal points are located substantially at the center of the air layer 25.

Although not shown in the figure, the liquid crystal display device 1 has a liquid crystal driver circuit (not shown in the figure) that drives display with respect to the liquid crystal display panel 11, a sensor controller (not shown in the figure) that controls driving of the optical sensor elements 4 and that receives light receiving signals from the plurality of optical sensor elements 4 that output light receiving signals corresponding to the intensity of received light, and the like.

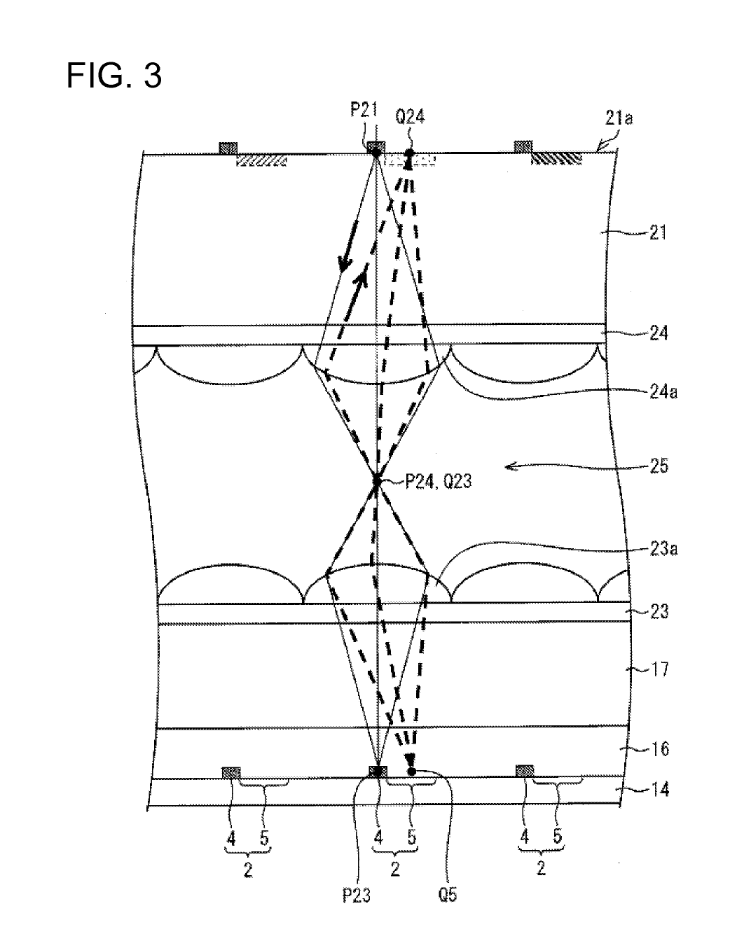

Next, with reference to FIGS. 1 and 3, a case in which the liquid crystal display device 1 functions as an image reading device and a case in which the liquid crystal display device 1 functions as an image display device are described. FIG. 3 is a cross-sectional view schematically showing a configuration of a main portion of the liquid crystal display device 1 shown in FIG. 1.

First, the case in which the liquid crystal display device 1 functions as an image reading device using the scanner function of the liquid crystal display device 1 is described.

As shown in FIG. 1, when the original 30 on which an image, characters, or the like are printed is placed on the surface 21a of the protection plate 21 by a user to obtain image information, light emitted from the backlight 20, such as white light, infrared light, or the like, is transmitted through the respective display cells 5 to irradiate the placed original 30. The light irradiated onto the original 30 is reflected as light having the amount and the wavelength corresponding to the printed content depending on the difference in reflectance of the image printed on the printed surface of the original 30.

The light reflected by the original 30 is reflected as diffused light into the protection plate 21. As shown in FIGS. 1 and 3, the light reflected into the protection plate 21 as diffused light is collected by the respective convex lenses 24a of the lens array 24, and is emitted to the air layer 25. The reflected light from the original 30 emitted to the air layer 25 forms an image substantially at the center of the air layer 25, i.e., substantially at the center between the respective convex lenses 24a and the respective convex lenses 23a. A point at which an image is formed with the reflected light from the original 30 by the convex lens 24a is an image formation point P24 shown in FIG. 3, and a point on the surface 21a of the protection plate 21 corresponding to the image formation point P24 is an object point P21 shown in FIG. 3.

Then, as shown in FIGS. 1 and 3, the reflected light from the original 30 forming an image at the image formation point P24 is respectively collected by the respective convex lenses 23a of the lens array 23. The reflected light from the original 30 collected by the respective convex lenses 23a is respectively collected by the optical sensor elements 4. Therefore, images are formed with the reflected light from the original 30 at the respective optical sensor elements 4 by the respective convex lenses 23a. A point at which an image is formed with the reflected light from the original 30 on the optical sensor element 4 by the convex lens 23a is an image formation point P23 shown in FIG. 3.

This way, in the liquid crystal display device 1, an inverted real image of an image printed on the original 30 including the object point P21 is formed at the image formation point P24, which is an intermediate image point, and an inverted real image of the intermediate image plane including this image formation point P24 is formed on the light receiving surface, which is the image plane of the optical sensor element 4 including the image formation point P23. This way, the liquid crystal display device 1 forms an erect image forming optical system as a whole.

As described, according to the liquid crystal display device 1, the reflected light from the original 30 is formed as erect images on the respective optical sensor elements 4 disposed on the active matrix substrate 14. Therefore, a scan image (read out image) having high resolution can be obtained.

In the present embodiment, an optical axis including the object point P21 and the image formation point P24 and an optical axis including the image formation point P24 and the image formation point P23 are on the same straight line. Therefore, images can be formed with the reflected light from the original 30 accurately on the optical sensor elements 4 by the convex lenses 23a and 24a. As a result, a scan image of the original 30 having a high resolution can be obtained.

Further, the boundaries where the refractive index significantly changes in the optical paths of the reflected light from the original 30 before the light is received by the respective optical sensor elements 4 arranged on the active matrix substrate 14 are at only two locations, which are the interface between the lens array 24 (refractive index n=1.5) and the air layer 25 (refractive index n=1.0) and the interface between the air layer 25 (refractive index n=1.0) and the lens array 23 (refractive index n=1.5). Therefore, a scan image of the original 30 having high resolution can be obtained.

Here, if the protection plate 21 is formed of an acrylic material, the refractive index of the protection plate 21 is approximately 1.5, and the refractive index of the material of the front polarizing plate 17 is approximately 1.47. Therefore, the optimum value of the refractive index of the lens array 23 and the lens array 24 is approximately n=1.5. Here, the refractive index of the lens array 23 and the lens array 24 is not limited to n=1.5.

Next, with reference to FIG. 3, the case in which the liquid crystal display device 1 functions as an image display device is described.

As shown in FIG. 3, when the original 30 is not placed on the surface 21a of the protection plate 21, in order to display an image on the surface 21a of the protection plate 21, light emitted from the backlight 20 is transmitted through the display cells 5 arranged adjacent to the optical sensor elements 4. The transmitted light transmitted through the display cells 5 is collected by the respective convex lenses 23a of the lens array 23, and is emitted to the air layer 25. The transmitted light transmitted through the display cells 5 to be emitted to the air layer 25 forms an image substantially at the center of the air layer 25, i.e., substantially at the center between the respective convex lenses 23a and the respective convex lenses 24a. A point at which an image is formed with the transmitted light transmitted through the display cell 5 by the convex lens 23a is an image formation point Q23, and the point on the display cell 5 corresponding to the image formation point Q23 is an object point Q5.

In the present embodiment, the respective convex lenses 23a and the respective convex lenses 24a are arranged so that the image formation point Q23 and the image formation point P24 match each other.

The transmitted light from the display cell 5, which formed an image at the image formation point Q23, is respectively collected by the respective convex lenses 24a of the lens array 24. The transmitted light from the display cell 5 collected by the respective convex lenses 24a is respectively collected on the surface 21a of the protection plate 21. Thus, an image is formed with the transmitted light from the display cell 5 on the surface 21a of the protection plate 21 by the respective convex lenses 24a. A point at which an image is formed with the transmitted light from the display cell 5 by the convex lens 24a on the surface 21a of the protection plate 21 is an image formation point Q24.

The image formation point Q24 is located substantially at the center of the respective convex lenses 24a and the respective convex lenses 23a. Therefore, the transmitted light from the display cell 5 is sufficiently collected by the convex lens 24a, thereby making it possible to suppress lowering of resolution of an image displayed on the surface 21a of the protection plate 21.

As described, according to the configuration of the liquid crystal display device 1, the transmitted light transmitted through the display cells 5 is formed as an erect image on the surface 21a of the protection plate 21. Therefore, an image can be displayed on the surface 21a without lowering the display quality of the image. Here, the display quality of an image means viewing angle characteristics, blurriness (resolution), contrast, and the like.

The boundaries where the refractive index significantly changes in the optical paths of the transmitted light that was emitted from the backlight 20 and that was transmitted through the display cell 5 before the light is collected on the surface 21a of the protection plate 21 are at only two locations, which are the interface between the lens array 23 (refractive index n=1.5) and the air layer 25 (refractive index n=1.0) and the interface between the air layer 25 (refractive index n=1.0) and the lens array 24 (refractive index n=1.5). Therefore, a display image having high resolution can be displayed.

Further, the respective convex lenses 23a and convex lenses 24a may be provided corresponding to the respective pixel regions 2. Alternatively, a pair of convex lenses 23a and 24a may be provided for a plurality of pixel regions 2.

The arrangement relationship of the convex lenses 23a, the convex lenses 24a, the optical sensor elements 4, and the display cells 5 can be appropriately optimized by a person skilled in the art depending on the usage conditions under which the liquid crystal display device 1 is used.

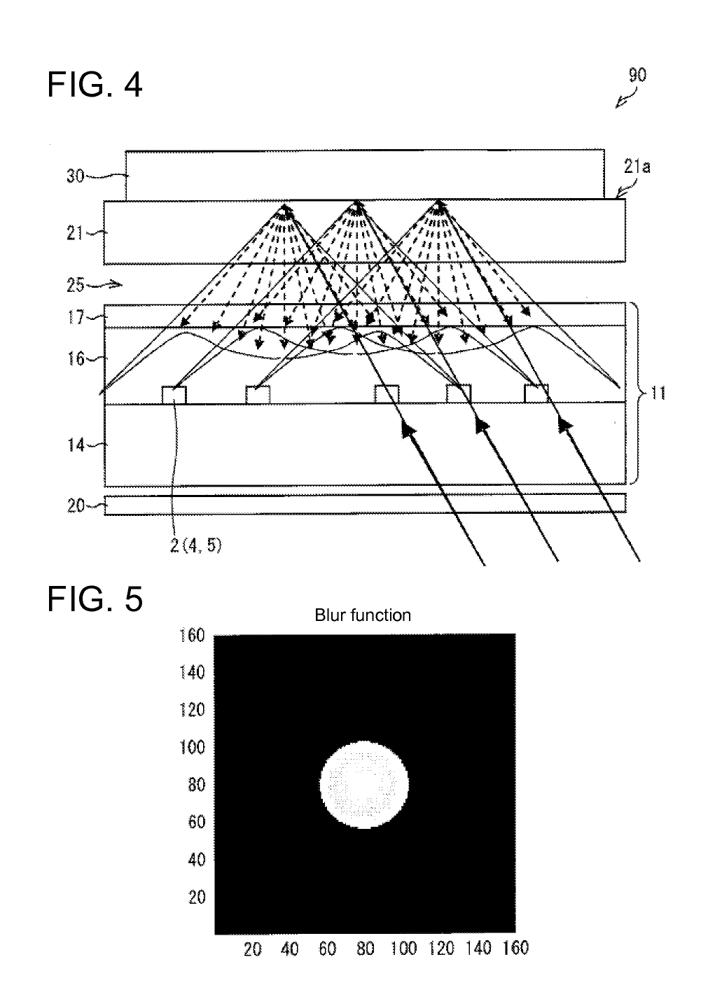

Here, with reference to FIGS. 4 to 6, a liquid crystal display device having built-in optical sensor elements in which the lens arrays 23 and 24 are not provided is described.

FIG. 4 is a cross-sectional view showing a configuration of a main portion of a liquid crystal display device having built-in optical sensor elements in which the lens arrays are not provided and paths of light reflected by the original 30.

A liquid crystal display device 90 shown in FIG. 4 has a configuration of the liquid crystal display device 1 from which the lens arrays 23 and 24 are removed. The rest of the components of the liquid crystal display device 90 are the same as those of the liquid crystal display device 1.

When using the liquid crystal display panel 11 having optical sensor elements 4 as a scanner, actual resolution of a read out image obtained by the optical sensor elements 4 is determined by optical distances from the optical sensor elements 4 to the original 30 placed on the surface 21a of the protection plate 21 rather than by the arrangement density of the optical sensor elements 4 that can be manufactured.

In the configuration of the liquid crystal display device 90, structures, such as the color filter substrate 16, the front polarizing plate 17, the air layer 25, the protection plate 21, and the like, are disposed between the optical sensor elements 4 and the original 30 placed on the surface 21a of the protection plate 21. The optical distance is increased by the thickness of the respective structures.

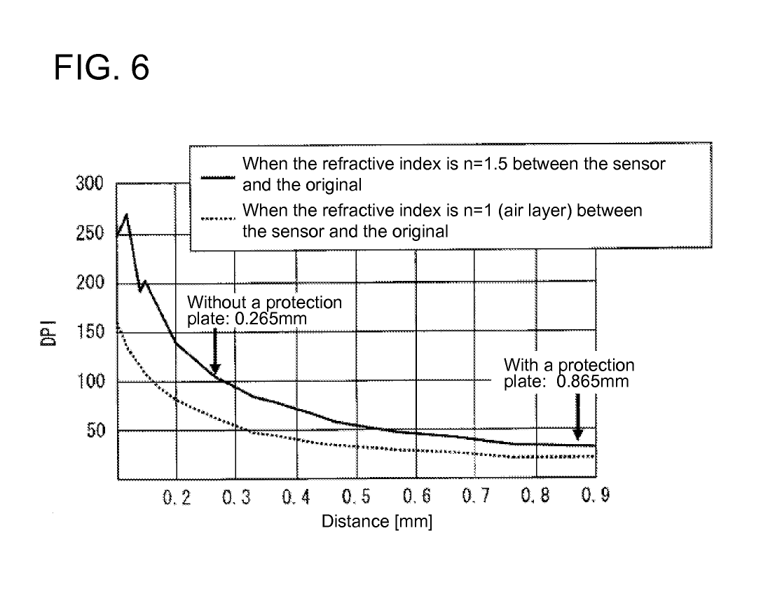

FIG. 5 is a figure showing a blur function of an image read out by the optical sensor element 4 of the liquid crystal display device 90. FIG. 6 is a graph showing the relationship between an optical distance between the light receiving surface of the optical sensor element 4 and an object for image reading and actual resolution in the liquid crystal display device 90 having no lens arrays. The horizontal axis in FIG. 6 shows the distance (mm) between the light receiving surface of the optical sensor element 4 and the object for image reading such as the original 30 or the like. The vertical axis in FIG. 5 shows the actual resolution (DPI).

As shown in FIG. 6, in the liquid crystal display device 90 having no lens arrays, it can be said that the actual resolution (DPI) decreases as the optical distance between the light receiving surface of the optical sensor element 4 and the object for image reading increases.

Further, as shown in FIG. 5, in the liquid crystal display device 90 having no lens arrays, it can be said that the read out image becomes a blurry image having a low quality.

As described, in the liquid crystal display device 90 having no lens arrays, only an actual resolution of an read out image proportional to the optical distance between the light receiving surface of the optical sensor element 4 and the object for image reading is obtained. Therefore, the actual resolution of the read out image obtained by the optical sensor element 4 is significantly lowered.

On the other hand, as described above, in the liquid crystal display device 1, (1) the lens array 24 is provided on the rear surface side (surface on the opposite side from the surface 21a) of the protection plate 21; (2) the lens array 23 is provided on the surface of the front polarizing plate 17; and (3) the optical sensor elements 4 are provided at focal points of the lens arrays 23.

According to the liquid crystal display device 1, diffused reflected light irradiated onto the original 30 placed on the surface 21a of the protection plate 21 can be collected by the configuration (1). Further, reflected light from the original 30 that was transmitted through the lens array 24 can be collected by the configuration (2). Further, images can be formed with the reflected light from the original 30 that was transmitted through the lens array 23 on the light receiving surfaces of the respective optical sensor elements 4 by the configuration (3).

Therefore, according to the present embodiment, the liquid crystal display device 1 having an image reading function that has both a high resolution image display function and a high resolution image reading function (scanner function) can be achieved.

Here, as an example of an image display device having a lens array, an image display device described in Patent Document 2 has been known.

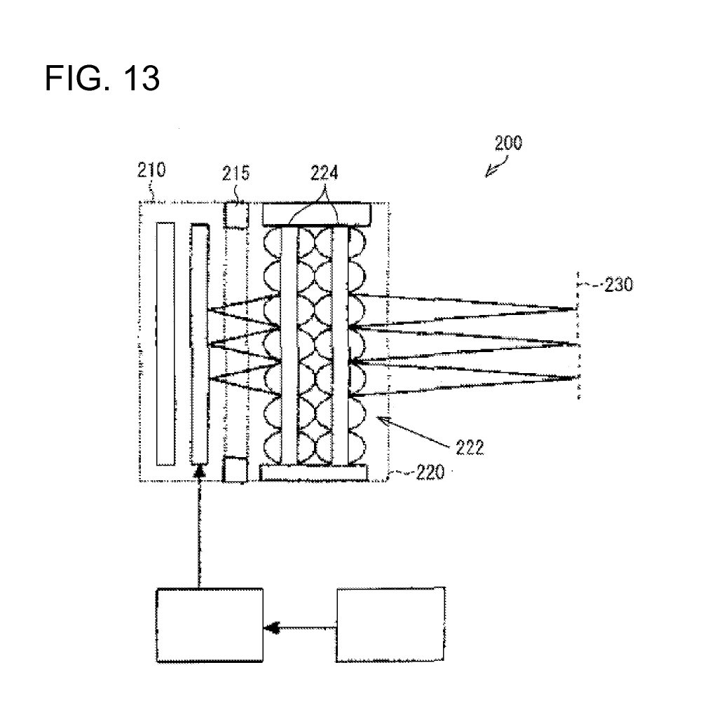

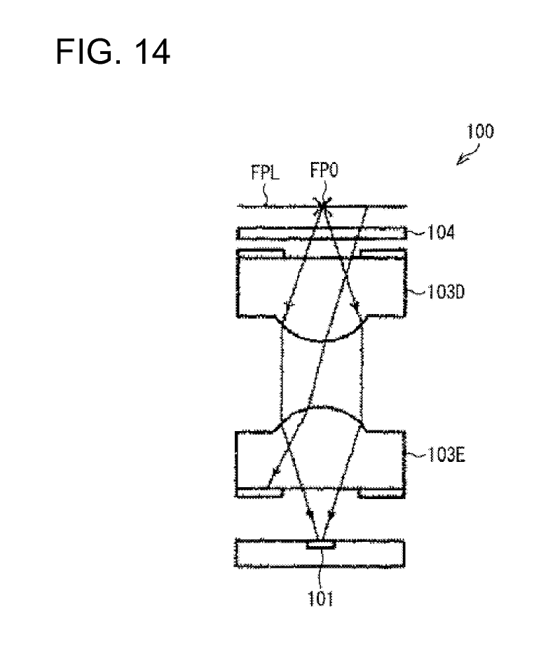

FIG. 13 is a cross-sectional view showing a configuration of the image display device described in Patent Document 2.

An image display device 200 displays a two-dimensional image including a stereoscopic image, and includes an LCD (color liquid crystal display device) 210 and an image transmission panel 220 supported by a support member 215 that is secured to the LCD 210. The image transmission panel 220 forms an image formation surface 230 in a space located on the opposite side from the LCD 210, and includes a microlens array 222.

The LCD 210 is a display section having a flat image display surface that displays a two-dimensional image including a stereoscopic image. The microlens array 222 is an erect equal-magnification optical system for making a visible two-dimensional image including a stereoscopic image written onto the image display surface, and is constituted of a plurality of microlenses that are arranged two-dimensionally. The microlens array 222 is a micro convex lens plate formed by integrating two pieces of lens array half units 224 as a set.

As described, in the conventional image display device, the lens array is used in order to dispose the image formation surface 230 in space. Furthermore, as described above, the purpose of the lens array described in Patent Document 2 is different from that of the present invention as described above. Because of this, it is arranged in a completely different manner.

Until now, there has been no example in which a lens array is used in order to provide a display device having an image reading function. Further, in such a display device having an image reading function, there has been no example in which, for the purpose of protecting the display panel and suppressing lowering of resolution of the read out image and the display image, a lens array is used to form an image with light emitted from a display panel as an erect image on a surface of a protection member, as well as to form, when an object for image reading, such as the original 30 or the like, is placed on the protection member, an image with reflected light of light irradiated onto the object for image reading on optical sensor elements (light receiving elements) of the display panel.

Here, in the present embodiment, the case in which the lens arrays 23 and 24 are provided as the optical members of the present invention between the liquid crystal display panel 11 and the protection plate 21 was described as an example.

However, the present embodiment is not limited thereto. The optical members are not particularly limited as long as they are optical members that can form an image with light emitted from the liquid crystal display panel 11 as an erect image on the surface 21a of the protection plate 21 and when an object for image reading is placed on the protection plate 21, that can form an image with reflected light of light irradiated onto the object for image reading on the optical sensor elements 4. An optical element such as a hologram, a prism, or the like, for example, or a combination of these may be used.

Further, in the present embodiment, the case in which the optical sensor elements 4 are provided in the respective pixels was described as an example. However, the optical sensor element 4 does not necessarily have to be provided in each pixel. The respective optical sensor elements 4 may be provided in subpixels in which any one of RGB color filters is provided, for example. Alternatively, a single optical sensor element 4 may be provided for a plurality of pixels.

### Embodiment 2

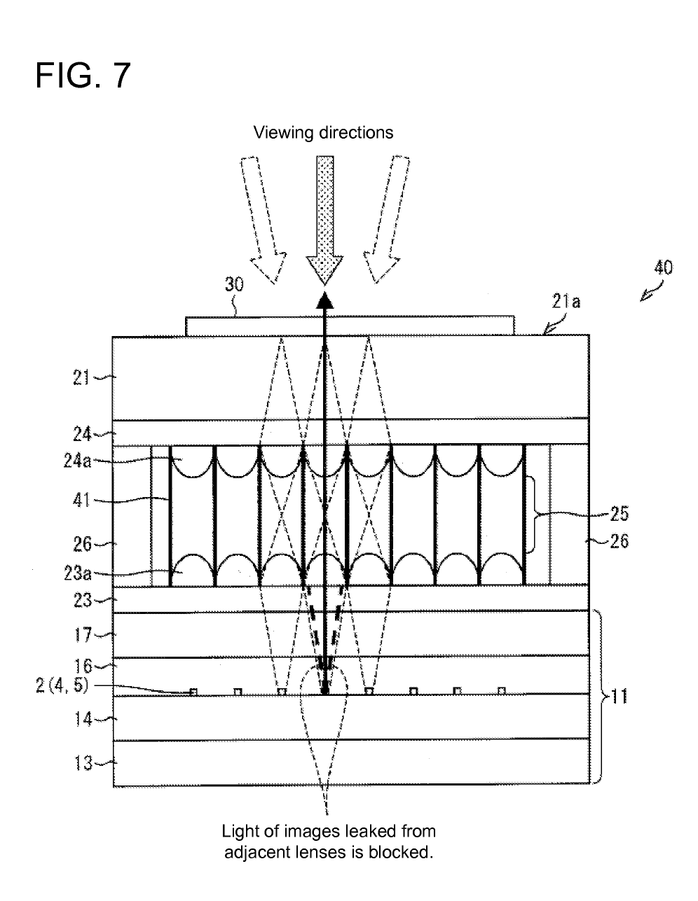

Another embodiment of the present invention is described as follows with reference to FIGS. 7 to 11. To facilitate description, members having the same functions as those in figures described in Embodiment 1 are given the same reference characters, and their description is omitted.

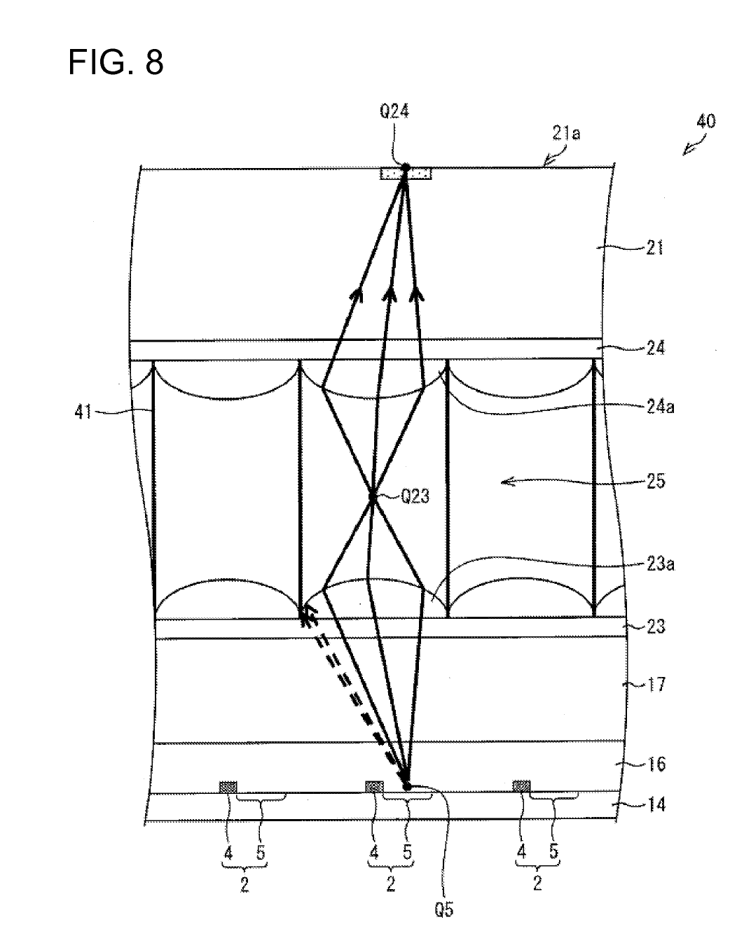

FIG. 7 is a cross-sectional view schematically showing a configuration of a liquid crystal display device 40 according to the present embodiment. FIG. 8 is a cross-sectional view showing a configuration of a main portion of the liquid crystal display device 40 shown in FIG. 7.

As shown in FIGS. 7 and 8, the liquid crystal display device 40 has a configuration of the liquid crystal display device 1 to which light shielding walls 41 are added in the air layer 25 to shield light between the respective convex lenses 23a and 24a.

The light shielding walls 41 are disposed between a pair of convex lenses 23a and 24a and the adjacent convex lenses 23a and 24a. The light shielding walls 41 prevent light transmitted through the convex lenses 23a or 24a from entering the convex lenses 24a or the convex lenses 23a that are disposed adjacent to the opposite convex lens 24a or the opposite convex lens 23a.

A material of the light shielding walls 41 is not particularly limited as long as it is a light shielding material. The material of the light shielding walls 41 may be a metal material (regular reflection material), such as silver, aluminum, or the like, or a diffuse reflection material, such as a white plastic, a white paint, or the like, for example.

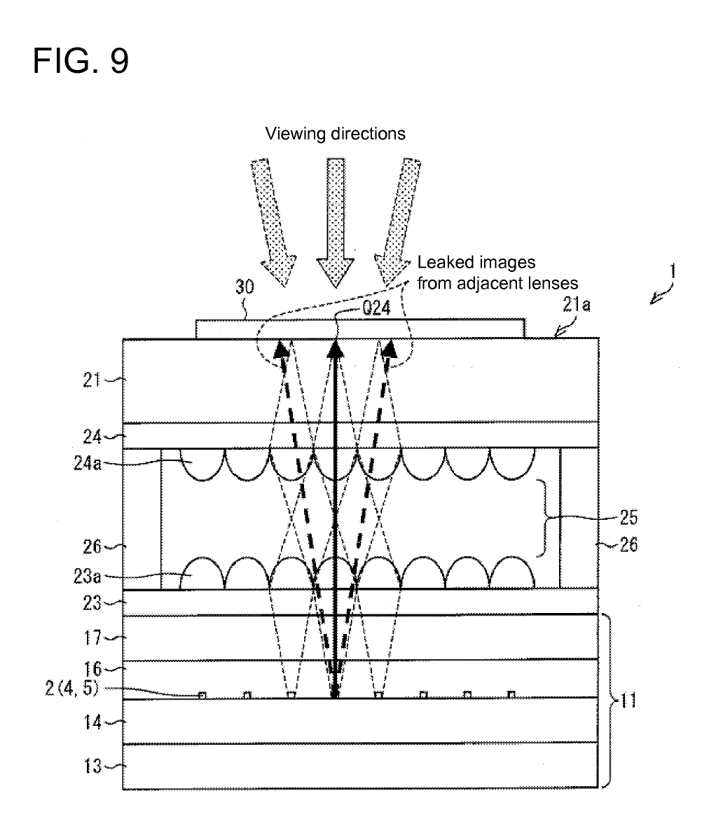

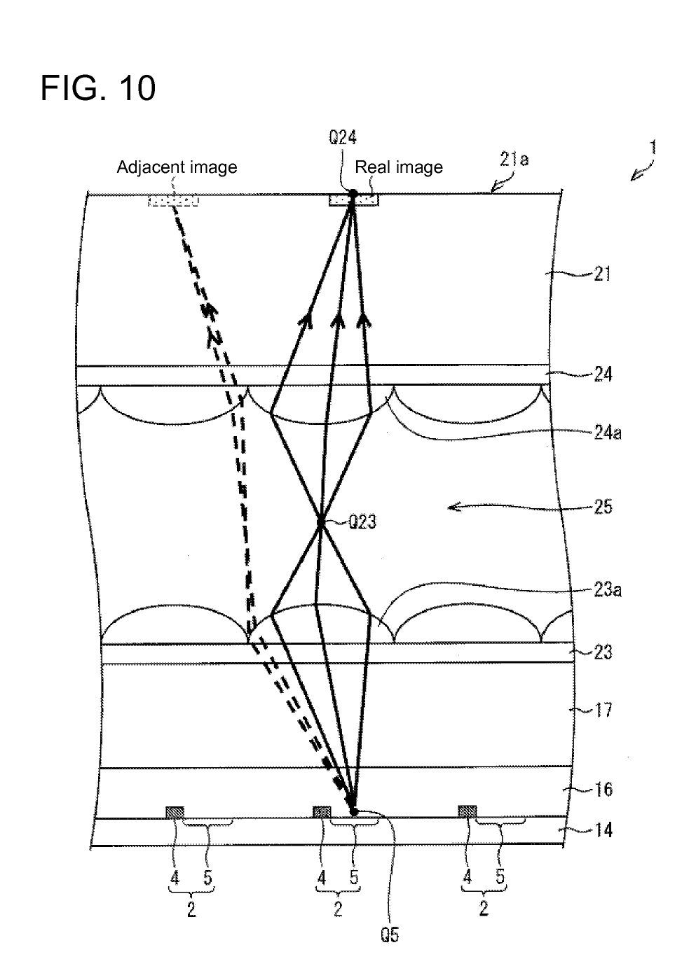

FIG. 9 is a cross-sectional view showing paths of light emitted from the liquid crystal display panel 11 of the liquid crystal display device 1 shown in FIG. 1. FIG. 10 is a cross-sectional view showing a main portion of the liquid crystal display device 1 shown in FIG. 9.

As shown in FIG. 9, in the configuration of the liquid crystal display device 1, displaying an image, some of the transmitted light transmitted through the display cell 5 and the corresponding convex lens 23a is collected by the convex lenses 24a that are adjacent to the corresponding convex lens 24a. This way, the transmitted light collected by the convex lenses 24a that are adjacent to the corresponding convex lens 24a forms an image at an image formation point that is different from the image formation point Q24.

As shown in FIG. 10, the reason for this is that, of the transmitted light transmitted through the display cell 5, the light transmitted through the proximity of the periphery of the convex lens 23a, particularly, is not collected by the corresponding convex lens 24a and is collected by the convex lens 24a that is adjacent to the corresponding convex lens 24a.

This transmitted light collected by the convex lens 24a that is adjacent to the convex lens 24 corresponding to the display cell 5 causes an image displayed on the surface 21a of the protection plate 21 to be blurry (noise) as an image leak.

On the other hand, as shown in FIG. 8, in the configuration of the liquid crystal display device 40, the light shielding walls 41 are formed between a pair of convex lenses 23a and 24a and the adjacent convex lenses 23a and 24a. By providing the light shielding walls 41 this way, the transmitted light transmitted through the display cell 5 and the corresponding convex lens 23a in order to display an image can be prevented from being collected by the convex lenses 24a adjacent to the corresponding convex lens 24a.

As described, according to the configuration of the liquid crystal display device 40, the image leak can be prevented. Therefore, according to the configuration of the liquid crystal display device 40, a liquid crystal display device having a scanner function that has both a higher resolution image display function and a high resolution scanner function can be achieved by preventing blurriness of a picture displayed on the surface 21a of the protection plate 21.

As described above, according to the liquid crystal display device 40, stray light from the periphery of the optical sensor elements 4, which becomes a noise, can be prevented from entering by (4) providing an opening by the light shielding walls 41 on the light receiving surface side of the optical sensor elements 4 in addition to the above-mentioned configurations (1) to (3).

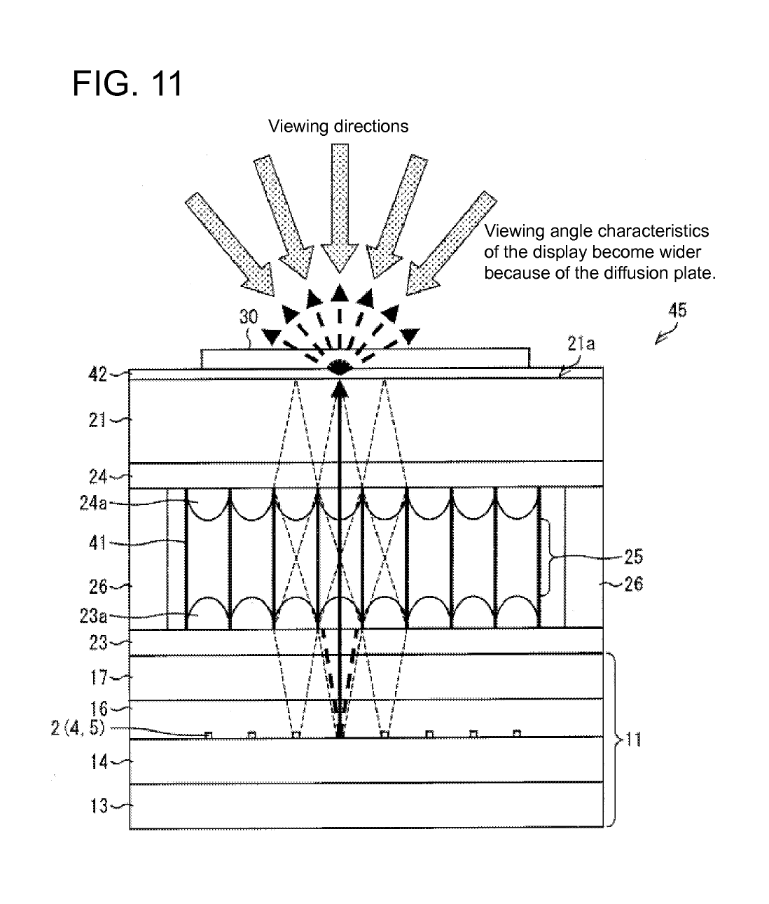

Further, as shown in FIG. 11, a diffusion plate 42 for diffusing light may be disposed on the surface 21a of the protection plate 21 of the liquid crystal display device 40.

FIG. 11 shows a configuration of a liquid crystal display device 45 in which the diffusion plate 42 is disposed on the surface 21a of the protection plate 21 of the liquid crystal display device 40.

As shown in the liquid crystal display device 45, when the diffusion plate 42 is disposed on the surface 21a of the protection plate 21, transmitted light transmitted through the display cell 5 and the convex lenses 23a and 24a to display an image is diffused by the diffusion plate 42 to be emitted to the outside of the liquid crystal display device 45. Because of this, according to the configuration of the liquid crystal display device 45, wider viewing angle characteristics can be achieved. This way, according to the configuration of the liquid crystal display device 45, a liquid crystal display device having wider viewing angle characteristics can be achieved in addition to the effects obtained by the configuration of the above-mentioned liquid crystal display device 40.

### Embodiment 3

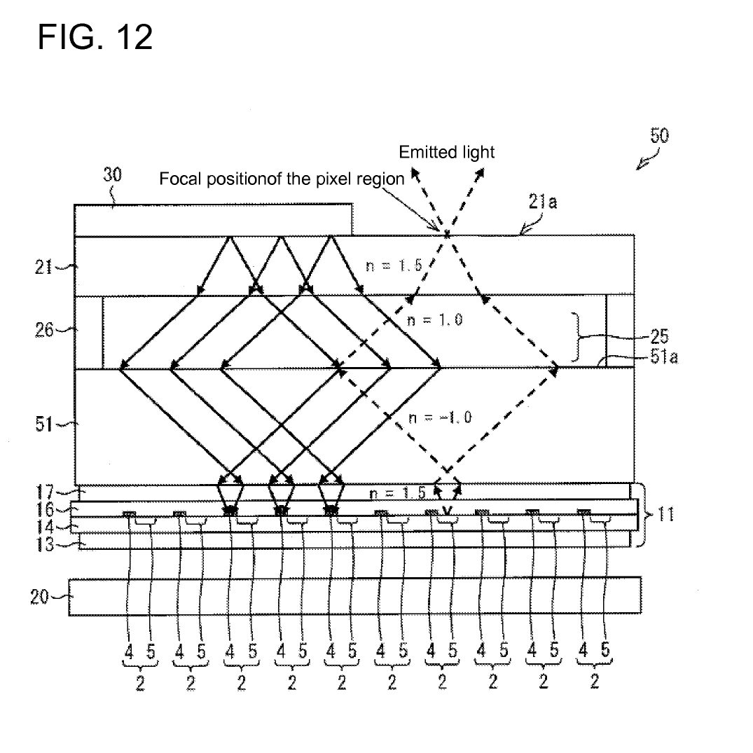

Another embodiment of the present invention is described as follows with reference to FIG. 12. Here, to facilitate description, members having the same functions as those in figures described in Embodiments 1 and 2 are given the same reference characters, and their description is omitted.

FIG. 12 is a cross-sectional view schematically showing a configuration of a liquid crystal display device 50 according to the present embodiment.

The liquid crystal display device 50 is different from the liquid crystal display device 1 in that it has a superlens 51 instead of the lens arrays 23 and 24 of the liquid crystal display device 1.

A superlens is a generic term for a lens having a superlens effect in which the amount of reflected light in a micro region increases due to a near filed effect caused by a negative refractive index, and is a lens formed of a so-called metamaterial having a negative refractive index.

The refractive index and the material of the superlens 51 are not particularly limited as long as the superlens 51 has a negative refractive index. Here, in the present embodiment, the superlens 51 having a refractive index of n=−1.0 was used.

The superlens 51 is formed of a photonic crystal, a metamaterial material, or the like, for example. Materials described in Patent Documents 3 to 7 can be used. The smaller the value of the refractive index of the superlens 51 is, the thinner the superlens 51 can be made.

As shown in FIG. 12, in the liquid crystal display device 50, the superlens 51 is disposed on the front polarizing plate 17 (i.e., a surface of the front polarizing plate 17 that is the surface on the opposite side from the surface on which the color filter substrate 16 is disposed).

In the liquid crystal display device 50, a plurality of spacers 26 and 26 are disposed on a surface 51a of the superlens 51 (the surface on the opposite side from the surface on which the front polarizing plate 17 is disposed). The protection plate 21 is supported by the plurality of spacers 26 and 26. The air layer 25 is formed between the superlens 51 and the protection plate 21 by the spacers 26 and 26.

In FIG. 12, light paths of reflected light from the original 30 when the liquid crystal display device 50 functions as a scanner are represented by solid arrows. Light paths of light transmitted through the display cell 5 when the liquid crystal display device 50 functions as an image display device are represented by dashed arrows.

In the liquid crystal display devices 1, 40, and 45 shown in Embodiments 1 and 2, two lens sheets, which are the lens arrays 23 and 24, were used. However, if the superlens 51 is used as in the liquid crystal display device 50, it is sufficient to use only one lens sheet.

The thicknesses and the refractive indices of the color filter substrate 16, the front polarizing plate 17, the superlens 51, and the protection plate 21 are respectively designed such that transmitted light that is emitted from the backlight 20 and that is transmitted through the display cells 5 forms a focal point on the surface 21a of the protection plate 21.

In the liquid crystal display device 50, when the original 30 is placed on the surface 21a of the protection plate 21 by a user, light emitted from the backlight 20, such as white light, infrared light, or the like, is transmitted through the respective display cells 5 to irradiate the placed original 30. The light irradiated onto the original 30 is reflected as light having the amount and the wavelength that correspond to the printed content depending on the difference in reflectance printed on the printed surface of the original 30.

The light reflected by the original 30 is reflected as diffused light into the protection plate 21. The reflected light reflected into the protection plate 21 as diffused light enters the superlens 51 through the air layer 25. The reflected light that entered the superlens 51, which is diffused light, is collected inside the superlens 51 by the negative refractive index of the superlens 51 and then forms an image. Then, the reflected light forms an image again on the light receiving surfaces of the respective optical sensor elements through the front polarizing plate 17 and the color filter substrate 16, and enters the respective optical sensor elements 4.

Thus, the reflected light that was emitted from the backlight 20 and that was then reflected by irradiating the original 30 placed on the surface 21a of the protection plate 21 is formed as an erect image on the respective optical sensor elements 4 arranged on the active matrix substrate 14. This way, according to the configuration of the liquid crystal display device 50, a higher resolution scan image of the original 30 can be obtained.

Further, in order to display an image on the surface 21a when the original 30 is not placed on the surface 21a of the protection plate 21, the light emitted from the backlight 20 is transmitted through the display cells 5, which are disposed adjacent to the optical sensor elements 4. The transmitted light that is transmitted through the display cells 5 enters the superlens 51 through the color filter substrate 16 and the front polarizing plate 17.

Then, the transmitted light that has entered the superlens 51 first forms an image when it is collected inside the superlens 51 by the negative refractive index of the superlens 51, and diffuses again. Because of the negative refractive index of the superlens 51, the transmitted light diffused inside the superlens 51 is refracted such that the light is collected through the air layer 25 and the protection plate 21 when it is emitted outside the superlens 51. Then, the transmitted light collected through the air layer 25 and the protection plate 21 forms an image on the surface 21a of the protection plate 21. This way, an image is displayed on the protection plate 21 by the liquid crystal display panel 11.

Thus, the transmitted light that was emitted from the backlight 20 and that was transmitted through the display cells 5 in order to display an image by the liquid crystal display panel 11 forms an erect image on the surface 21a of the protection plate 21. This way, according to the configuration of the liquid crystal display device 50, a high resolution image can be displayed on the surface 21a of the protection plate 21.

This way, according to the configuration of the liquid crystal display device 50, a liquid crystal display device having a scanner function that has both a high resolution image display function and a high resolution scanner function can be achieved.

In the liquid crystal display devices 1, 40, and 45 described above, due to an interference between the lens pitches of the respective convex lenses 23a and 24a of the lens arrays 23 and 24 and the pitch of the pixel regions 2 (display cells 5), a moiré (interference stripes) may occur in an image displayed on the surface 21a of the protection plate 21. Therefore, the liquid crystal display devices 1, 40, and 45, which use the lens arrays 23 and 24, need to be designed taking into account the moiré.

On the other hand, unlike the convex lenses 23a and 24a described above, the superlens 51 does not have boundaries between the lenses. Therefore, there is no visible optical boundary. Thus, in the liquid crystal display device 50, which uses the superlens 51, there is no need to take into account the moiré, and more flexible optical design can be obtained.

Here, the refractive index and the thickness of the superlens 51 and the height of the spacers 26 (i.e., the distance between the superlens 51 and the protection plate 21) are appropriately set so that the superlens 51 has the focal points described above.

Therefore, also in the present embodiment, the height of the spacers 26 can be appropriately set depending on the refractive index and the thickness of the superlens 51, and is not particularly limited. Similarly, the thickness of the superlens 51 can be appropriately set depending on the refractive index of the superlens 51 and the height of the spacers 26 as described above, and is not particularly limited.

In the present embodiment, as an example, the thickness of the protection plate 21 (refractive index n=1.5) is 0.4 mm; the height of the spacers 26 (i.e., the distance between the superlens 51 and the protection plate 21) is 0.4 mm; the thickness of the superlens 51 (refractive index n=−1.0) is 0.8 mm; and the thicknesses of the color filter substrate 16 and the front polarizing plate 17 (refractive index n=−1.5) are 0.2 mm.

Such a configuration of the liquid crystal display device 50 determines the position of the original 30 placed on the surface 21a of the protection plate 21 and the positions of the optical sensor elements 4 arranged on the active matrix substrate 14. In other words, the optical distance between the original 30 placed on the surface 21a of the protection plate 21 and the optical sensor elements 4 arranged on the active matrix substrate 14 is determined.

Here, in the respective embodiments described above, the liquid crystal display panel was described as an example of the display panel. However, the present invention is not limited thereto.

As the display panel, a display panel other than the liquid crystal display panel, such as an EL (electroluminescence) display panel, a plasma display panel, or the like, may be used, for example. Therefore, the display device according to the present invention is not limited to the liquid crystal display device, and may be an EL display device or a plasma display device, for example.

As described above, the display device of the present invention can be suitably used as a display device having an image reading function (scanner function) in various types of electronic devices that need either an image reading function or a display function such as a portable terminal having a scanner function (touch panel function) and the like, for example. The display device above has the image reading function as described above. Therefore, an image reading device and a display device, which used to be needed separately, can be integrated, which is very useful in providing multiple functions and conserving space.

The display device of the present invention is particularly suited for use in electronic devices, such as mobile phones, electronic dictionaries, portable audio devices, notebook PCs (personal computers), and the like, for example.

The present invention is not limited to the respective embodiments described above, and various modifications within the scope shown in the claims are possible. Embodiments obtained by appropriately combining technical means respectively disclosed in different embodiments are also included in the technical scope of the present invention.

As described above, the display device of the present invention is a display device having an image reading function that includes a display panel having a light receiving element; and a protection member protecting the display panel, wherein in performing the image reading function, an intensity of reflected light of light irradiated onto an object for image reading disposed on the protection member is detected by the light receiving element to read out image information of the object for image reading. The display panel and the protection member are arranged with a gap therebetween. The display device includes, between the display panel and the protection member, an optical member that forms an image with light emitted from the display panel as an erect image on a surface of the protection member and that forms, when an object for image reading is disposed on the protection member, an image with reflected light of light irradiated onto the object for image reading as an erect image on the light receiving element.

According to the configuration above, the object for image reading is not placed directly on the display panel because the display device has the protection member. Furthermore, even when stress is added to the protection member when the object for image reading is placed on the protection member, stress to the display panel can be prevented because the display panel and the protection member are arranged with a gap between them. As a result, the display panel can be protected.

Further, the optical member forms an image with light emitted from the display panel as an erect image on a surface of the protection member. When an object for image reading is disposed on the protection member, the optical member forms an image with reflected light of light irradiated onto the object for image reading as an erect image on the light receiving element. Therefore, visual characteristics can be made equal to those of when the optical member is not disposed.

Further, according to the configuration above, the optical member is provided between the display panel and the protection member. Therefore, even if the distance between the image display surface, which also functions as a surface on which an object for image reading is placed, and the display panel is increased by the protection member, it is possible to suppress lowering of the display quality of an image displayed on the surface of the protection member, and it is possible to suppress lowering of resolution of a read out image detected by the light receiving element. Here, the display quality means visual characteristics, blurriness (resolution), contrast, and the like.

Thus, according to the configuration above, a display device having an image reading function that can protect the display panel and that can suppress lowering of resolution of a read out image and lowering of the display quality of a displayed image can be provided.

In the display device described above, the optical member preferably includes the first lens member that has a positive refractive index and that is disposed on the surface of the display panel facing the protection member and the second lens member that has a positive refractive index and that is disposed on the surface of the protection member facing the liquid crystal display panel with a gap from the first lens member.

According to the configuration above, light emitted from the display panel can be formed as an erect image on the surface of the protection member by the first lens member and the second lens member. Furthermore, when an object for image reading is placed on the protection member, reflected light of light irradiated onto the object for image reading can form an image on the light receiving element. Therefore, according to this configuration, it is possible to suppress lowering of resolution of both a read out image and a displayed image.

Furthermore, the first lens member and the second lens member preferably are lens arrays in which a plurality of convex lenses are arranged respectively. The convex lenses of the first lens member and the convex lenses of the second lens member preferably are arranged to face each other.

According to the configuration above, the position at which light emitted from the display panel forms an image and the position at which reflected light of light irradiated onto the object for image reading placed on the protection member forms an image can be appropriately adjusted in a simple manner by adjusting the respective focal positions of the convex lenses of the first lens member and the convex lenses of the first lens member, which are arranged to face each other.

Further, between the first lens member and the second lens member, a light shielding member for preventing light transmitted though one of the convex lenses that are facing each other from entering convex lenses disposed adjacent to the other one of the convex lenses facing each other preferably is disposed.

According to the configuration above, the light transmitted through one of the convex lenses facing each other can be prevented from entering the convex lenses disposed adjacent to the other one of the convex lenses facing each other. As a result, light can be prevented from entering a light receiving element that is not the target light receiving element, and light can be prevented from being irradiated onto display regions in the protection member corresponding to the adjacent pixels. Therefore, according to this configuration, it is possible to prevent lowering of resolution of a read out image and a displayed image further.

Further, on a surface of the protection member on which the object for image reading is placed, a diffusion member that diffuses and emits light preferably is disposed. Because of this configuration, an image formed on the surface on which the object is placed is diffused by the diffusion member, and is emitted to the outside. Thus, the viewing angle characteristics can be improved.

Alternatively, in the display device, the optical member preferably is a lens member having a negative refractive index.

By using a lens member having a negative refractive index as the optical member, light emitted from the display panel can be formed as an erect image on the surface of the protection member. When an object for image reading is placed on the protection member, reflected light of light irradiated onto the object for image reading can form an image on the light receiving element. As a result, according to this configuration, it is possible to suppress both lowering of resolution of a read out image and lowering of the display quality of a displayed image.

When a lens member having a negative refractive index is used as the optical member, the lens member does not have to be a lens array in which a plurality of convex lenses or the like are disposed, for example. Therefore, the interference stripes (moiré) caused in a displayed image by interference between the pitches between the respective lenses of the lens array and the pitches between pixels can be prevented.

### INDUSTRIAL APPLICABILITY

The display device of the present invention can be suitably used as a display device having an image reading function (scanner function) in devices that require a high resolution scan image and a high resolution display image.

### DESCRIPTION OF REFERENCE CHARACTERS

1 liquid crystal display device (display device)
2 pixel region
4 optical sensor element (light receiving element)
5 display cell (pixel)
11 liquid crystal display panel (display panel)
20 backlight
21 protection plate (protection member)
21a surface
25 air layer (gap)
23 lens array (first lens member, optical member)
23a convex lens
24 lens array (second lens member, optical member)
24a convex lens
30 original (object for image reading)
40 liquid crystal display device (display device)
41 light shielding wall (light shielding member)
42 diffusion plate (diffusion member)
45 liquid crystal display device (display device)
50 liquid crystal display device (display device)
51 superlens (lens member, optical member)

1. A display device having an image reading function, comprising a display panel having a light receiving element; and a protection member protecting said display panel,
wherein in performing the image reading function, an intensity of reflected light of light irradiated onto an object for image reading disposed on said protection member is detected by said light receiving element to read out image information of said object for image reading,
wherein said display panel and protection member are disposed with a gap therebetween, and
wherein the display device further comprises, between said display panel and said protection member, an optical member that forms an image with light emitted from said display panel as an erect image on a surface of said protection member and that forms, when an object for image reading is disposed on said protection member, an image with reflected light of light irradiated onto said object for image reading as an erect image on said light receiving element.

2. The display device according to claim 1, wherein said optical member includes a first lens member that has a positive refractive index and that is disposed on an surface of said display panel facing said protection member and a second lens member that has a positive refractive index and that is disposed on a surface of said protection member facing said display panel with a gap from said first lens member.

3. The display device according to claim 2, wherein said first lens member and second lens member are lens arrays in which a plurality of convex lenses are arranged respectively, and
wherein the convex lenses of said first lens member and the convex lenses of said second lens member are arranged to face each other.

4. The display device according to claim 3, wherein between said first lens member and second lens member, a light shielding member for preventing light transmitted through one of the convex lenses facing each other from entering a convex lens disposed adjacent to the other one of the convex lenses facing each other is disposed.

5. The display device according to claim 1, further comprising a diffusion member that diffuses and emits light on a surface of said protection member on which said object for image reading is to be placed.

6. The display device according to claim 1, wherein said optical member is a lens member having a negative refractive index.
